(19) United States
(12) Patent Application Publication
(10) Pub. No.: US 2002/0167645 A1
(43) Pub. Date: Nov. 14, 2002

(54) System and method for selectively viewing or printing images from a reflective device using an arrangement of polarizers and a polarizing beam splitter

(76) Inventor: Bruce K. Johnson, Elkins, NH (US)

Correspondence Address: Polaroid Corporation, Patent Department, 784 Memorial Drive, Cambridge, MA, 02139, US

(21) Appl. No.: 09/852,586

(22) Filed: May 10, 2001

(51) Int. Cl. G03B 21/14

(52) U.S. Cl. 353/20

(57) ABSTRACT

A system and method for projecting an image from an image source for viewing or printing using a beamsplitter and multiple polarizers which selectively transmit and extinguish undesirable polarized light. An image source projects image illumination polarized along a predetermined linear axis of polarization towards a beamsplitter made of a light-transmissive substrate and a substantially non-polarizing, light-reflective layer positioned such that the polarized image illumination from the image source reflects off the light-reflective layer towards an image output. First and second polarizers are synthetic, light-transmitting, linearly-polarizing sheets, the first polarizer configured to intercept image illumination transmitted through the reflective layer of the beamsplitter, and absorb illumination polarized along said predetermined linear axis of polarization; the second polarizer positioned in the optical path between the light-reflective layer and the image output, and transmitting only image illumination that is polarized along the predetermined linear axis of polarization, and an image output receiving the polarized image illumination reflected off the polarizing beam splitter.

### FIELD

This invention in general, relates to the field of digital imaging, and, in particular, to a system and method for transmitting an image from a reflective device by using an arrangement of a polarizing beamsplitter with two polarizers that selectively transmit and extinguish light in a predetermined linear axis such that a reflective device projects the polarized image light toward a viewfinder or a photo sensitive medium for selectively viewing or printing the image respectively.

### BACKGROUND

Polarizing beamsplitters are widely known for eliminating undesirable light in an image. Conventional polarizing beamsplitters are in the form of a cube, composed of two triangular pieces of glass with a polarizing reflective coating at the interface. A polarizing beamsplitter splits a plane wave into two components: it reflects the S-component of the plane wave incident on a polarizing multi-layered film at a specified incident angle and causes the P-component to transmit. These are used for obtaining polarization of light and work very well but are expensive to manufacture. A less expensive method is to coat a thin piece of glass with reflective layers to form a beamsplitter which divides a beam of light into two directions. The result is a less efficient polarizer because not all ‘S’ component is reflected and not all ‘P’ component is transmitted, and there is also some undesirable light that is reflected from the second surface of the sheet beamsplitter as a ghost image. This can be reduced by coating the second surface with anti-reflective coatings. These are not 100% efficient, as they still yield a second surface reflection that is visible when making high contrast images on film. This may also be visually visible in a viewfinder typically as a displaced image of the primary image, of much lower intensity, but visible on a high contrast image. Therefore, there exists a need for eliminating undesirable polarized light that is devoid of second surface reflections, in order to achieve an image of acceptable quality. There also exists a need for providing a low cost, low power system, that prints an image that eliminates second surface reflections. The invention provides a beamsplitter-polarizer combination, that transmits only the ‘P’ light component and absorbs any ‘S’ light component. When this light strikes a white or light pixel on a liquid crystal display, the ‘P’ component of the light wave is rotated to become a ‘S’ component. This ‘S’ component is reflected on to the reflecting surface of the polarizing beamsplitter and is directed towards a projection lens system or a visual lens system through an optical coupling apparatus.

The second surface reflections can be eliminated by adjoining one of the polarizers to the polarizing beamsplitter. The adhesive material that connects the polarizer to the polarizing beamsplitter is made of a adhesive type material with an index of refraction to match that of the adjoining polarizer, so that any S-component of the polarized light will penetrate the adhesive layer and will be absorbed by the polarizer. A second polarizer is placed between the polarizing beamsplitter and the lens system to absorb any remaining ‘P’ component of the reflected image illumination so that only ‘S’ light is transmitted to the output lens system.

### SUMMARY

In response to the above need, the present invention provides an optical system and method that provides a means to project an image from a reflective surface that can be projected onto a photosensitive medium or into a viewfinder and also provides a means to reduce second surface reflections that appear as ghost images when using polarizing beamsplitters alone. The arrangement also eliminates astigmatism in the image that results from transmission of imaging light through a beamsplitter at a large angle in the imaging path. Further, it has been found that by using a reflective device like a liquid crystal display, instant images having good contrast and good resolution can be obtained. And further, in addition to its use in exposing film, the reflective flat panel display can also be used, if desired, for reviewing and/or previewing digitally captured images. The invention allows one to view the image with a lot less power.

Included in the optical system are first and second polarizers, each being synthetic, light-transmitting, linearly polarizing sheets, the first polarizer capable of absorbing illumination polarized along said predetermined linear axis of polarization, the second polarizer positioned in the optical path between the light-reflective layer and the image output, and capable of transmitting substantially only illumination that is polarized along a predetermined linear axis, and where the first polarizer is adjoining a polarizing beam splitter. The system further includes an image output capable of receiving the polarized image illumination reflected from the polarizing beamsplitter.

The present invention also provides several embodiments using a reflective device for printing and viewing images. In general, such embodiments comprise a housing and means for receiving and transmitting electronic image-encoding digital information; a reflective device capable of being electronically addressed in response to the electronic image-encoding digital information to provide in reflected light a reflection image. It also includes a reflection image viewer and a receptacle for holding a photosensitive imaging medium and an optical system capable of selectively directing the reflection image reflected off said reflective device toward either a photosensitive medium or a viewfinder.

The present invention contemplates a methodology having several modes of practice. The method comprises the steps of providing a polarizing beamsplitter, first and second polarizers and an image output. The method also provides an image source capable of projecting image illumination along a predetermined linear axis of polarization towards the polarizing beamsplitter. The polarizing beamsplitter comprises a light-reflective layer and a light-transmissive substrate. The polarizers are synthetic, light-transmitting, linerly polarizing sheets, the first polarizer is capable of absorbing illumination polarized along said predetermined linear axis of polarization, and the second polarizer is positioned in the optical path between the light-reflective layer and the the image output. The polarizers are capable of transmitting substantially only image illumination that is polarized along a predetermined axis. The image output of the method is capable of receiving polarized image illumination reflected from the polarizing beamsplitter.

In light of the above, a principal objective of the present invention is to project an image from a reflective device that can be viewed in a viewfinder or print on a photosensitive medium. A second objective is to provide a low cost and low power system to provide for the same.

The present invention discloses a system and method for projecting an image from a reflective device that includes an arrangement of polarizers and a polarizing beamsplitter in such a fashion as to provide an image that reduces undesirable polarized light.

It is another objective of the present invention to provide for an improved printer-viewer system and method that provides image illumination that is of acceptable quality and eliminates second surface reflections and astigmatism with improved cost and performance.

Other features of the invention will be readily apparent when the following detailed description is read in connection with the drawings.

### BRIEF DESCRIPTION OF THE DRAWINGS

The structure and operation of the invention, together with other objects and advantages thereof, may best be understood by reading the detailed description to follow in connection with the drawings in which unique reference numerals have been used throughout for each part and wherein:

FIG. 1 is the arrangement of polarizers and a polarizing beamsplitter used in the invention.

FIG. 2 is block diagram illustrating one embodiment of the present invention.

FIG. 3 is an optical block diagram of the present invention showing one embodiment of the various optical components.

FIG. 4 illustrates an exemplary reflective liquid crystal microdisplay that can be used in practice of certain embodiments of the present invention.

FIG. 5 illustrates an optical system directing the image output to selectively go toward a view finder and/or a printer.

FIG. 6 illustrates another embodiment of the present invention for directing the image toward a printer.

### DETAILED DESCRIPTION OF THE DRAWINGS

In accordance with the present invention, it has been found that good quality images can be projected from a reflective device onto a photosensitive medium by using a polarizing beamsplitter in optical arrangement with two polarizers such that the polarizers transmit an image in a predetermined linear axis of polarization thereby eliminating undesirable polarized light.

Included within the inventive optical arrangement of using the polarizing beamsplitter and polarizers is an image source, a polarizing beamsplitter, a first polarizer, a second polarizer and an image output. The image source is capable of projecting image illumination towards the polarizing beamsplitter, where the image illumination is being polarized along a predetermined linear axis of polarization. The polarizing beamsplitter comprises a light-transmissive substrate and a substantially non-polarizing light reflective layer, and the polarizing beamsplitter is positioned such that the polarized image illumination from the image source reflects off the light-reflective layer towards the image output. The first and second polarizers are synthetic, light-transmitting, linearly-polarizing sheets. The first polarizer is positioned to intercept the image illumination transmitted through said light-reflective layer, and is capable of absorbing image illumination polarized along the predetermined linear axis of polarization. The second polarizer is positioned in the optical path between the non-polarizing light-reflective layer and the image output, and is capable of transmitting substantially only illumination that is polarized along the predetermined linear axis of polarization. The image output is capable of receiving the polarized image illumination reflected off the polarizing beamsplitter.

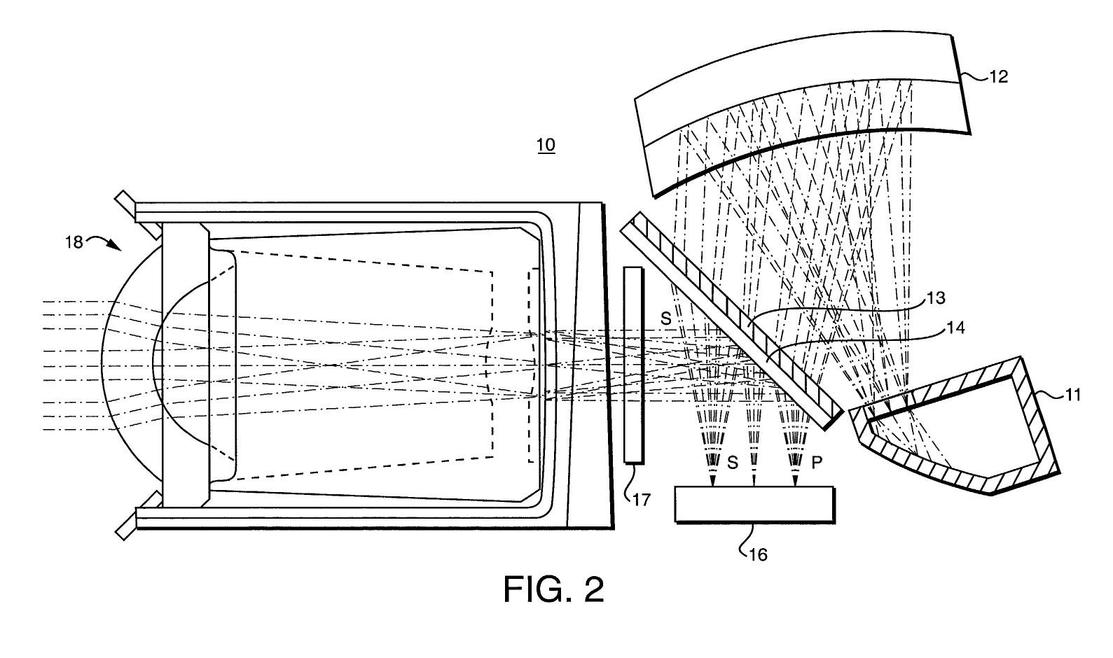

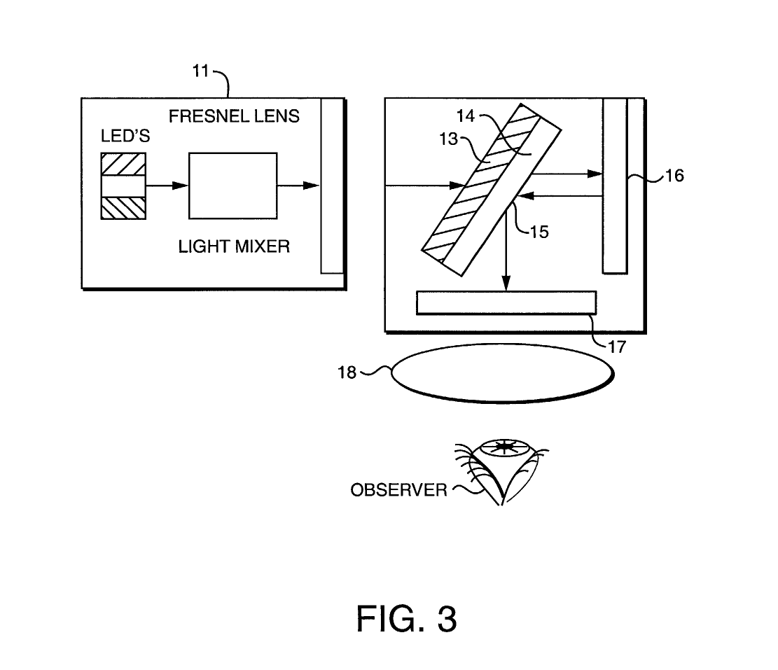

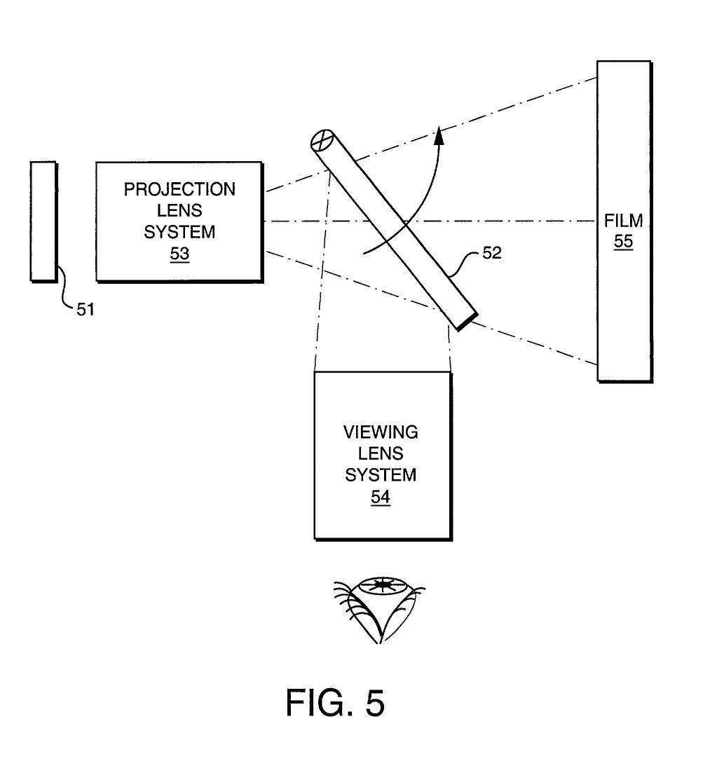

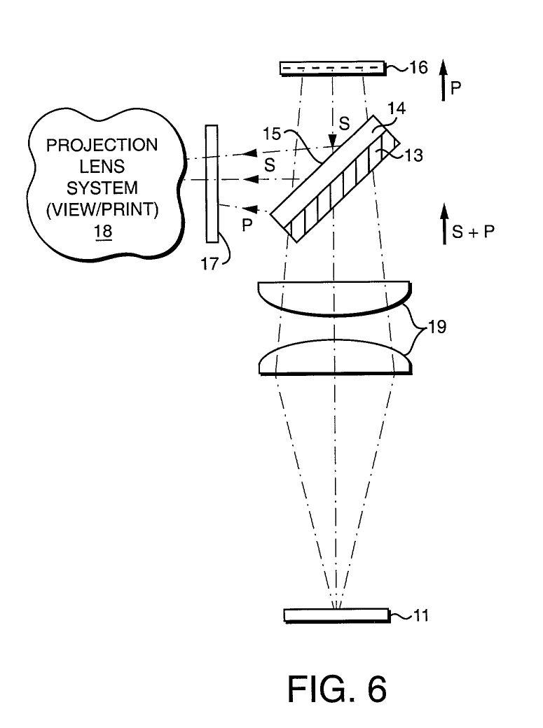

As used herein, the term “image output” is intended to encompass all devices and displays, and the collective components thereof, that are capable of receiving image-bearing illumination, and modulating and/or manipulating the same for a predetermined, desired, and useful end. Such image output encompass but are not limited to optical and/or photosensitive film, area-array printers, optical viewfinders, image projection systems, and electronic image capture devices and the like. A preferred image output is a viewfinder lens system allowing a user to perceive an image through a viewfinder eyepiece. See for example, FIGS. 3 and 5 described hereinafter. Another preferred image output is a projection lens system for directing image illumination to an optical printer for printing onto a photosensitive imaging medium. See for example, FIGS. 2 and 6, described hereinafter.

As used herein, the term “image source” is intended to encompass all devices and displays, and the collective components thereof, that are capable of either producing image-bearing illumination or conveying image-bearing illumination from another source thereof. A particularly desired image source, described in greater detail hereinbelow, incorporates a reflective flat panel display that is electronically addressed contemporaneously with the illumination thereof by a light source, to produce a reflection image in reflected light. Although the reflective liquid crystal display is preferably used, the invention is not limited to using the same and contemplates use of other image sources, for example, ferroelectric crystals and the like.

The polarizing beamsplitter, in the present invention is used in combination with a first polarizer such that the first polarizer adjoins the polarizing beamsplitter. While the applicant does not wish to be limited to any theory in explanation of the present invention, the intended purpose of the first polarizer is to extinguish the ‘S’ component of image illumination received from the image source and only transmit the ‘P’ component thereby providing an image incident from the light source in a predetermined linear axis of polarization. This facilitates the incoming light to the reflective flat panel display to be polarized. The purpose of adjoining the first polarizer to the polarizing beamsplitter is to avoid the reflection of image illumination from the second surface of the polarizing beamsplitter, while traversing the path between the image source and the projection lens.

It is highly desirable that the adhesive material that adheres the polarizer to the beamsplitter have an index of refraction matching or nearly matching in order that the undesirable ‘S’ component of light enters the polarizer before reflecting off any “air-glass” surface. If an air interface is posited between the beamsplitter and the polarizer, the ‘S’ component may penetrate the reflective-layer of the beamsplitter and reflect off the second internal surface of the beamsplitter. Consequently, some of this light could travel towards the projection lens and form a “ghost” or low intensity secondary image at the film plane.

In addition, some of the image illumination of the ‘S’ component that emerges from the second surface of the beamsplitter (the non-reflective coating surface) would also be reflected as an additional ghost image. An optically matching adhesive layer allows this unwanted ‘S’ component of image illumination to proceed into the first polarizer, and thus, is effectively absorbed before being reflected back as a second surface, undesirable ghost reflection image.

The invention allows other embodiments where the components of the optical components are arranged differently. One such system (see FIG. 6) provides a ‘print’ mode to direct the image toward a projection lens system for printing on to a photosensitive medium.

The preferred image source of the invention comprises a reflective liquid crystal display, which is envisioned to provide illumination of an image that has been polarized along a predetermined linear axis of polarization. The illumination image from the light source reaches the surface of the reflective display after transmission through the polarizing beamsplitter, when it undergoes a phase change and is reflected back towards the path of the polarizing beamsplitter. Although a ‘twisted nematic’ reflective liquid crystal display is used in the optical system disclosed here, the invention is not limited to the same. Other image sources, like piezo electric and ferro electric displays that alter the state of polarization can be used to provide the same effect.

A second polarizer is placed in the optical path of the image illumination between the polarizing beamsplitter and the projection lens system positioned such that it absorbs all illumination polarized along the predetermined linear axis of polarization (the ‘P’ component), and only transmits the desired light (the ‘S’ component).

In accordance with the invention, the polarizing beamsplitter in combination with the first polarizer, eliminates undesirable polarized light which usually manifests in the form of second surface reflections when using a beam splitter alone. Although light polarizers are available that provide linear or circular polarization, the invention is designed to use linearly polarized light. The production of linear light polarizers has been well described in the art. Linear light polarizers, in general, owe their properties of selectively passing radiation vibrating along a given electromagnetic radiation vector (and absorbing electromagnetic radiation vibration along a second given electromagnetic radiation vector) to the anisotropic character of the transmitting medium. Dichroic polarizers are linear polarizers of the absorptive variety and owe their light-polarizing capabilitites to the vectorial anisotropy of their absorption of incident lightwaves. Light entering a dichroic medium encounters two different absorption coefficients-one low and one high. The emerging light vibrates predominantly in the direction of low absorption.

The polarizers 17 and 13 can be any synthetic, optical media capable of linearly polarizing input illumination. In this regard, polarizers 17 and 13 will typically comprise any of a variety of materials which produce the desired light polarization effects. Preferred, and the most widely used type of synthetic polarizer, is the polyvinyl alcohol-iodine complex polarizer. It comprises a unidirectionally stretched, linearly oriented poyvinylalcohol sheet, supported on a suitable substrate, isotropic plastic material (e.g., cellulose acetate butyrate), and stained with a polyiodide solution. Such polarizers are commonly available from Polaroid Corporation as type H polarizer sheets, varieties therof being described in U.S. Pat. Nos. 2,173,304; 2,225,940; 2,306,108; 2,397,231; 2,453,186; and 2,674,159.

Alternatively, a synthetic polarizer based on a polyvinylene based chromophore species can be employed. Such “K-Sheef”-type polarizers are made by converting (i.e., rendering dichroic) the polyvinylalcohol molecules of a polyvinylalcohol sheet to polyvinylene light-polarizing species by catalytic dehydration, typically using hydrochloric acid vapor in the manner described in U.S. Pat. No. 2,445,555 (issued Jul. 20, 1948 to F. J. Binda). See also U.S. Pat. No. 5,666,223, issued to Bennett et al. on Sep. 9, 1997. Due to the good humidity resistance of such polyvinylene-based polarizers, their use is desirable for applications involving exposure adversely humid or moist environmental conditions.

The polarizing beamsplitter used in the invention consists of a thin piece of glass coated on one side with reflective layers to form a sheet beamsplitter. The reflective metal oxide coatings are made of TiO2, and SiO2, in alternate layers, of about ¼ wavelength thickness. TiO2 has a high index of reflection, and SiO2 has a low index of reflection. A first polarizer is placed adjoining the other side of the sheet beamsplitter to eliminate second surface reflections. The first polarizer is configured to transmit polarized light in a selected linear axis of polarization ‘P’ and designed to extinguish or absorb the other ‘S’ component of illumination image from the light source and reflective mirror completely. This ‘P’ polarized light is transmitted through the polarizing beamsplitter and first polarizer combination. This is a pure component of the ‘P’ orientation, as the ‘S’ component is effectively eliminated by the polarizer. When this ‘P’ component of the illumination light wave hits the light pixels on the liquid crystal display, the ‘P’ component is inherently twisted or rotated to become an ‘S’ wave. The ‘S’ component reflects off the polarizing beamsplitter and is directed towards a projection lens system or a visual lens system. Without an adjoining polarizer, a substantial portion, around 30% of the reflected ‘S’ component penetrates the polarizing beamsplitter coatings, and then a portion of this, 5% or more, reflects back towards the projection or viewing lens, and is imaged on the film or the eye as a displaced, unwanted, image. If the polarizer is glued or adjoined to the back of the beamsplitter, the ‘S’ component penetrates the glue layer (which has a matching index of reflection to the glass and the polarizer) and is absorbed. There is no ‘S’ component left to reflect back from the second surface (air to plastic or glass). Even if there were some ‘S’ component left, it goes once again through the first polarizer, and would be absorbed. The glue material is an optically matching adhesive and could be selected from a number of possibilities, such as, epoxy, thermal cements, contact cements, or acrylic glues. Any clear cement having an index of refraction near that of plastic or glass would suffice. The extinction ratio of polarizers is typically significantly better than 99/1 across the visible spectrum.

The reflectivity of the beamsplitter at 45 degrees to ‘S’ polarized light would be about 66%. The transmissivity of the ‘S’ component would be 1-0.66 or about 34%. Conversely, the transmission of ‘P’ polarized light would be about 66% and reflectivity would be about 34%. If the beamsplitter is used at 60 degrees from the normal, the S reflectivity would increase to about 88% and S transmission would be about 12%. The converse is true for ‘P’ light. These numbers apply to specific beamsplitters, and the numbers would be different for beamsplitters made with different number of coating materials and layers, and thickness of coatings. Therefore, the reflectivity and transmissivity also depend on the wavelength and the numbers above are illustrative for one particular beamsplitter.

A second polarizer, is placed in the path between the polarizing beamsplitter and the output lens system, the purpose of which is to absorb any ‘P’ component that may be remaining and only pass the ‘S’ component, in this case, only the desireable light from the reflecting first surface of the sheet polarizing beamsplitter. The arrangement described above shows the used in reflection to image the light from the LCD, rather than in transmission, as is more normally the case. This arrangement was chosen to eliminate astigmatism in the image that results from a polarizing beamsplitter at a large angle in the imaging path. Astigmatism is one of the aberrations of lenses which makes the lens reproduce a point light source as two lines at right angles lying in different focal planes.

The image thus received through the arrangement of a polarizing beamsplitter and two polarizers can be directed toward an image output lens system that consists of a selection means (not shown) for directing the image for view or print, a viewfinder to enable to view the image, and a photosensitive medium for printing the image.

The photosensitive medium for recording quality images can be conventional 35 mm silver halide emulsion film, self-developing diffusion transfer film, and the like, by using a reflective liquid crystal display. The liquid crystal display is used in reflection to provide an imagewise area exposure of the photosensitive medium.

The use of liquid crystals as reflective microdisplay devices are well known for achieving digital images that are of acceptable quality. In general, microdisplays are high-resolution, low-power, low-cost displays that are fabricated on an integrated circuit and range in size from a few millimeters to as much as 30 mm and range in resolution from quarter-VGA (VGA being 640×480 pixels) to UXGA (1600×1200 pixels). Because they are reflective and are not direct view displays, they are able to produce with optics, an image much larger than the physical size of the display, making such feature very attractive for less bulky portable digital image printing, and viewing devices.

The liquid crystal material is sandwiched between conductively coated glass and transistor pads. The transistor pads are typically made of Al, although Au and Ag can also be used. The LCD in its powered “off” state has the property of rotating the plane of polarization by 90 degrees effectively changing the P polarized light to S, which is reflected from the LCD. This ‘S’ component travels the optical path from the reflective display to the lens system via the polarizing beamsplitter and a second polarizer. The lens system can be a projection lens sytem which thereafter projects the image illumination towards a photosensitive medium or a visual lens system which directs the image towards a viewfinder for viewing. In the powered “on” state which can be applied to individual pixels on the LCD, the plane of polarization is not rotated. Additionally, by applying partial power or voltage to a pixel, the LCD may only partially rotate the plane of polarization. Some S light may then proceed through the system giving partial exposures or “grey” levels as opposed to full on or off. When light containing the ‘P’ transmissive component of the light wave hits the LCD which is of a twisted helix type, the ‘P’ component undergoes a phase change and is reflected as a ‘S’ component before it is reflected off the polarization beam splitter.

While the structure of microdisplays is subject to much variation, an exemplary microdisplay structure is depicted for illustrative purposes in FIG. 5.

Micro displays can be commercially obtained, for example from: Colorado MicroDisplay, Inc., of Boulder, Colo., under the product designations CMD3X2A, CMD8X6D, and CMD8X6P; Three-Five Systems, Inc., of Tempe, Arizona, under the LcOS trade designation; and the MicroDisplay Corporation of Berkeley, California, under the product designations MD640, MD800, and MD1024. Although mention is made of specific product designations, the invention is not limited to using this brand of liquid crystal displays and is envisioned to work with any number of other companies that manufacture similar liquid crystal displays.

Displaytech, Inc., of Longmont, Colorado, currently manufactures a ferroelectric liquid crystal microdisplay under the trade designation of RGB Fastfilter. The RGB Fastfilter is an example of a dye absorption filter constructed with fast switching ferroelectric liquid crystal (FLC) cells. These cells have switching speeds that greatly exceed those of the more common nematic liquid crystals. However, the molecular switching actions of ferroelectric liquid crystals—unlike nematic liquid crystals—is not voltage dependent and thus provides only bistable states. Accordingly, displays employing ferroelectric liquid crystals may have comparatively lower attainable grey levels as a function of voltage, and rely upon time modulation for use in a digital camera viewfinder or printer.

Reflective microdisplays use an external light source, and modulate the light as it reflects off the microdisplay. While the present invention is not limited to any particular light source for the illumination of the reflective flat panel display, the light source is preferably a light emitting diode which provides even, uniform, white light. For full color imaging, light-emitting diodes for each of the primary color components of white light (i.e., red, green, and blue) can be used. LEDs are popularly used because they turn on easily, within a short period of time, like a few microseconds. Other light sources such as tungsten or arc lamps could be used with a color filter wheel.

An external light source is commonly used in conjunction with a reflecting mirror for directing projected captured images to a focal plane and further reflecting the image in the path of the polarizer adjoining the polarizing beamsplitter. The orientation of the illumination optics is not important. In a compact arrangement, the illumination optics consists of a single concave mirror, in combination with a light source.

In addition to structural embodiments, the present invention also includes a method embodiment. More particularly, the present invention contemplates a method for projecting an image, through various optical elements, ultimately toward an image output. The method generally comprises the steps of (a) providing a polarizing beam splitter in combination with polarizers and the so-called image output, (b) providing an image source, and (c) directing polarized image illumination reflected off the polarizing beam splitter toward said image output.

In respect of the image source, said image source is one capable of projecting image illumination towards said beam splitter. Further, the image illumination should be polarized along a predetermined linear axis of polarization. Example of image sources have been described in respect of the structural embodiments above.

In respect of the polarizing beamsplitter, said polarizing beamsplitter shall comprise a light-transmissive substrate and a light-reflective layer. Further, the polarizing beamsplitter should be positioned such that the polarized image illumination from the image source reflects off the light-reflective layer towards the image output. Again, examples of the polarizing beamsplitter have been described in respect of the structural embodiments above.

In respect of the first and second polarizers, the first and second polarizers are each synthetic, light-transmitting, linearly-polarizing sheets. The first polarizer is positioned to intercept the image illumination transmitted through the light-reflective layer, the first polarizer capable of absorbing illumination polarized along the predetermined linear axis of polarization, the second polarizer being positioned in the optical path between the light-reflective layer and the image output, and the second polarizer capable of transmitting substantially only illumination that is polarized along the predetermined linear axis of polarization.

The method embodiment of the invention, provides a beamsplitter, a first and second polarizer and an image output. The polarizing beamsplitter in combination with the first polarizer is positioned such that the first polarizer receives image illumination from a light source and polarizes the image along a predetermined linear axis of polarization. It also provides an image source capable of projecting image illumination towards the polarizing beamsplitter along a predetermined linear axis of polarization. The beam splitter is used in combination with the first polarizer such that the polarizer is adjoining the beamsplitter. The first polarizer provides the purpose of extinguishing the ‘S’ component of image illumination received from the light source and only transmits the ‘P’ component thereby providing an image incident from the light source in a predetermined linear axis of polarization to facilitate incoming light to the reflective flat panel display to be polarized. The second polarizer is positioned in the optical path between the light-reflective layer and the image output, and is capable of transmitting substantially only illumination that is polarized along said predetermined linear axis of polarization towards an image output. The image output directs the image illumination toward a projection lens system for printing or towards a viewing lens system for viewing.

Attention is now directed to certain specific embodiments of the present invention.

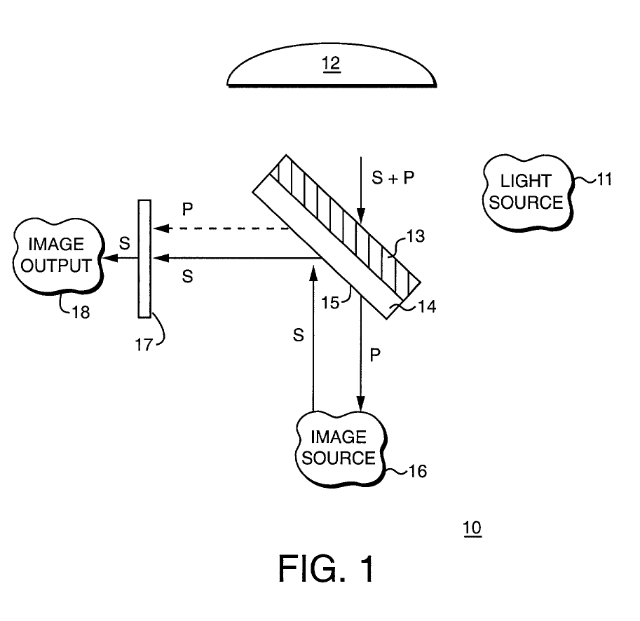

FIG. 1 is an expanded view of the important optical components of the invention. As shown in FIG. 1, the optical system 10 comprises a polarizing beamsplitter 14 adjoining a first polarizer 13. The polarizing beamsplitter has a reflective surface 15 on the side facing away from the polarizer. The combination is positioned to receive incident light from image illumination of a light source 11, reflected off a reflecting miror 12. White light incident on the polarizer contains the S and P component combined at the angle of incidence. The first polarizer 13 effectively absorbs the ‘S’ component and transmits the ‘P’ component which is directed towards the image source 16 through the reflective layer 15. The image source 16 could be a reflective liquid crystal display. The illumination image, which has been polarized along a linear axis of polarization, after reaching the reflective liquid crystal display 16 undergoes a phase change and is reflected back towards the reflective surface 15 of the polarizing beamsplitter 14. The light that is reflected from the liquid crystal display is shown as ‘S’ component. This ‘S’ component is reflected towards the image output 17. There is a fraction of the ‘S’ component that is transmitted through the polarizing beamsplitter 14, which is eventually absorbed as it enters the first polarizer 13. Image output 18 can be a lens system for directing images towards a projection lens for printing the image on a photosensitive medium or towards a viewing lens system (not shown). FIG. 1 shows an enlarged view of the polarizing beamsplitter combination and the polarizers, showing the optical path of the image illumination, and the extinction and transmission of the light wave as it traverses the path of the image source, beamsplitter, first polarizer and second polarizers and image output.

FIG. 2 is a block diagram illustrating one embodiment of the present invention. It illustrates an optical system 10 comprising a polarizing beamsplitter 14 in combination with a first polarizer 13 embodying the invention. This combination consists of a first polarizer 13, situated to receive incident light from image illumination of a light source 11, reflected off a reflecting mirror 12, the first polarizer 13 adjoining the surface of a polarizing beamsplitter 14. The light source 11 is a light box containing red, green, blue (R,G,B) light emitting diodes (not shown). The first polarizer is configured to extinguish the ‘S’ plane of polarized light and only transmit ‘P’ light. This ‘P’ component is transmitted through the polarizing beamsplitter that is adjoining the first polarizer and is in the optical path of the liquid crystal display 16. The reflective display in its ‘off’ state rotates the polarization vector of the image illumination that was incident on the liquid crystal display and in turn travels the optical path between the polarizing beamsplitter 14 and image output 18 via the second polarizer 17 and produces an image of acceptable quality. Polarizers 13 and 17 are well known and are of the type manufactured by many. Output lens system 18 further provides to selectively direct the illumination image to a viewfinder for viewing or to a photosensitive film for printing (not shown). The light source 11 of FIG. 2 uses a light box containing light emitting R,G,B diodes. The reflecting concave mirror 12 is used for bringing parallel rays of light falling on it to a real focus.

FIG. 3 is an optical block diagram of the various optical components used in the polarizing beamsplitter combination. It depicts the illumination optics and polarization optics. In this embodiment the illumination optics comprises a Light Emitting Diode along with a Fresnel lens. The first polarizer 13 adjoining the polarizing beamsplitter 14 is used for transmitting polarization along a predetermined linear axis of polarization. Light illumination is transmitted through the polarizing beam splitter 14 and is then reflected off the reflective display 16, which in turn is directed towards the Eyepiece lens of the viewfinder/observer after undergoing a reflection at the reflecting surface 15 of the polarizing beamsplitter 14.

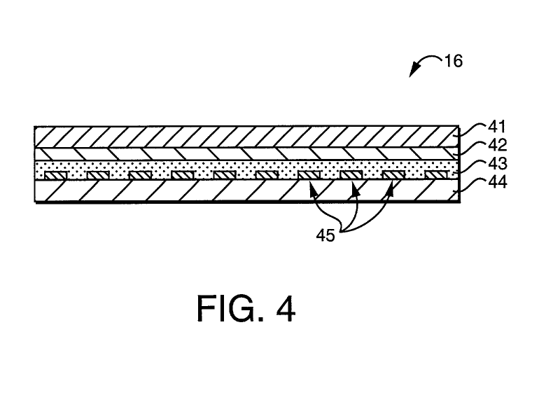

The liquid crystal device shown in FIG. 4 is employed for producing grey scale images according to techniques well-known in the art. The reflective display as shown in FIG. 4 comprises an electro optic layer 43 disposed between a first substrate 41 and a second substrate 44. The first substrate has a single electrode known as a common electrode 42. Second substrate 44 has a plurality of pixel electrodes 45, each of which periodically acquires updated image data in an independent manner. Each pixel electrode 45 retains the image data acquired for a given period of time or duration, after which the acquired image data is replaced with new image data. The substrates 41 and second substrate 42 are transparent to light, with the coating of the pixels 45 being light reflective. Preferably, substrate 44 contains the electronic circuit. According to one embodiment of the invention, electrooptic layer 43 comprises liquid crystal material.

FIG. 5 illustrates another embodiment of the present invention pertaining to a different orientation of the viewing and projecting lens systems which is more compact. FIG. 5 provides a display apparatus 51 being in optical communication therewith a viewing lens system 54 or a projection lens system 53 by use of an optical coupling system 52 which selectively directs the image to go towards a viewfinder or to film for printing. If the system is used in the projection mode for printing, the optical coupling device 52 is suitably moved out of optical communication with the projection lens system 53. Similarly, when the system is used in the viewing mode, the optical coupling device 52 is suitably moved into optical communication with the projection lens system 53, and the image is viewed through a viewfinder (eyepiece).

In embodiments wherein compactness is not a principal consideration, greater latitude is available for the arrangement of the optical components of the present invention. FIG. 6 is such an embodiment. Here, the projection lens system 18 can be used in the ‘print’ or ‘view’ mode to direct the image for printing on to a photosensitive medium or viewing on to a viewfinder. In this configuration, the first polarizer 13 adjoins the polarizing beamsplitter 14, and is configured to provide absorption of the ‘S’ component and only transmit the ‘P’ component of the incident image illumination directed from an illumination source 11. FIG. 6 illustrates the optical system comprising a light source 11 which projects image illumination via condenser lenses 19 to a first polarizer 13. First polarizer polarizes light along a predetermined axis of polarization, and this ‘P’ component of the light wave is transmitted through the polarizing beamsplitter 14 towards the reflective device 16. The polarizing beamsplitter has a high reflective coating on the surface closer to the reflective liquid crystal display 16. A portion of this ‘P’ component is reflected when it reaches the reflective coating surface of the beamsplitter. This component is depicted as the ‘P’ undesirable light going toward the second polarizer 17 where it is absorbed. The ‘P’ component that travels to the reflective display, in effect gets rotated to become a ‘S’ component when it travels to the projection lens system 18 via the polarizing beamsplitter 14 first and then the second polarizer 17. The ‘S’ polarized light is transmitted to the projection lens sytem through the second polarizer 17.

Although, there are other embodiments of the invention that configure the polarizing beamsplitter to be used in transmission the sharpness of the image is degraded a little by going through a tilted beamsplitter. A small amount of astigmatism is created which will slightly blur each pixel. The blur can be about the size of the pixel. By reflecting the image off the beamsplitter, no astigmatism is created.

While the present invention has been shown and described by reference to certain embodiments, it will be appreciated that many changes and modifications may be made therein by one skilled in the art in view of the present disclosure without departing from the essential spirit of the invention as defined in the following claims:

1. An optical apparatus comprising an image source, a beamsplitter, first and second polarizers, and an image output;
said image source capable of projecting image illumination towards said beamsplitter, said image illumination being polarized along a predetermined linear axis of polarization;
said beamsplitter comprising a light-transmissive substrate and a substantially non-polarizing light reflective layer, said beamsplitter being positioned such that the polarized image illumination from said image source reflects off the light10 reflective layer towards said image output;
the first and second polarizers each being synthetic, light-transmitting, linearly-polarizing sheets, the first polarizer being positioned to intercept the image illumination transmitted through said light-reflective layer, the first polarizer capable of absorbing illumination polarized along said predetermined linear axis of polarization, the second polarizer being positioned in the optical path between the light-reflective layer and the image output, the second polarizer capable of transmitting substantially only illumination that is polarized along said predetermined linear axis of polarization; and
said image output capable of receiving the polarized image illumination reflected off the beamsplitter.

2. An optical apparatus as in claim 1, wherein said first polarizer is adjoining the front surface of the beam splitter.

3. The optical apparatus as in claim 1, wherein said image source further comprises a reflective flat panel display and a light source, said reflective flat panel display providing in reflection said image illumination upon incidence thereon of illumination originating from said light source.

4. An optical apparatus as in claim 2, wherein said reflective flat panel display is a micro liquid crystal display configured to work in portable image acquisition devices.

5. An optical apparatus as in claim 2, wherein said image source further comprises a reflecting mirror for directing projected captured images in the optical path of the polarizer adjoining the beamsplitter.

6. An optical apparatus as in claim 2, wherein said image output is capable of selectively directing the image illumination reflected off said reflective flat panel display toward either (a) a photosensitive imaging medium for printing thereof or (b) toward a viewfinder for the viewing thereof of the image illumination.

7. A method of projecting an image comprising the steps of:
(a) providing a beam splitter, first and second polarizers, and an image output;
(b) providing an image source capable of projecting image illumination towards said beam splitter, said image illumination being polarized along a predetermined linear axis of polarization;
said beamsplitter comprising a light-transmissive substrate and a light-reflective layer, said beamsplitter being positioned such that the polarized image illumination from said image source reflects off the light-reflective layer towards said image output;
the first and second polarizers each being synthetic, light-transmitting, linearly-polarizing sheets, the first polarizer being positioned to intercept the image illumination transmitted through said light-reflective layer, the first polarizer capable of absorbing illumination polarized along said predetermined linear axis of polarization, the second polarizer being positioned in the optical path between the light-reflective layer and the image output, the second polarizer capable of transmitting substantially only illumination that is polarized along said predetermined linear axis of polarization; and
c) directing said polarized image illumination reflected off the polarizing beam splitter toward said image output.
